(19) United States
(12) Patent Application Publication
(10) Pub. No.: US 2012/0059704 A1
(43) Pub. Date: Mar. 8, 2012

(54) PRODUCT INFORMATION PROCESSING APPARATUS AND PRODUCT INFORMATION PROCESSING METHOD

(75) Inventor: Toshio Yanagi, Osaka (JP)

(73) Assignee: TOSHIBA TEC KABUSHIKI KAISHA, Tokyo (JP)

(21) Appl. No.: 13/220,889

(22) Filed: Aug. 30, 2011

(30) Foreign Application Priority Data
Sep. 2, 2010 (JP) 2010-197128

(51) Int. Cl. G06Q 30/00

(52) U.S. Cl. 705/14.27; 705/14.38

(57) ABSTRACT

A product information processing apparatus includes: an image importing section which imports an image imaged by an imaging section; a service label detecting section which detects a service label in which incentive content obtained from purchasing of the product is expressed in a visually unrecognizable form, from a product image imported by the image importing section; and a notifying section which notifies the incentive content of the service label detected by the service label detecting section.

### CROSS-REFERENCE TO RELATED APPLICATION

This application is based upon and claims benefit of priority from Japan Provisional Application No. 2010-197128 filed on Sep. 2, 2010, the entire contents of which are incorporated herein by reference.

### FIELD

Embodiments described herein relate generally to a product information processing apparatus and a product information processing method.

### BACKGROUND

In the related art, a retail store such as a supermarket provides services such as a price discount for a customer registered as a member. For example, the customer who is the member is graded according to a store usage frequency or a total amount of payment, and the price discount may be provided according to the grade. In this way, the member can receive the incentive of the provided service, whereas the store can increase the number of shopping occasions of the member to promote sales.

Further, product management in the store is performed by a product code such as JAN (Japan Article Number), and the product code is affixed to each product in the form of a barcode or the like. With regard to reading of the barcode affixed to the product, there is known a technique which reads the product code from a product barcode imaged using an image sensor such as a CCD (Charge Coupled Device) or a CMOS (Complementary Metal Oxide Semiconductor), and transmits the read product code to a POS (Point Of Sale) terminal.

However, when the store actually provides the price discount according to the grade of each member, it is necessary to propose a discount amount (or product price) according to the member grade for each product. However, if the price difference is exposed to the customer who visits the store, this may lower the customer's desire to buy.

### DESCRIPTION OF THE DRAWINGS

FIG. 1 is a perspective view schematically illustrating a configuration of a checkout system according to a first embodiment.

FIG. 2 is a block diagram illustrating a configuration of a POS terminal and a product code reader.

FIG. 3 is a diagram illustrating an example of a PLU file.

FIG. 4 is a diagram illustrating an example of a membership master file.

FIG. 5 is a diagram illustrating an example of a discount master file.

FIG. 6 is a diagram illustrating an example of the relationship between an imaged area of an imaging section and a product thereof.

FIG. 7 is a diagram illustrating an example of a service label.

FIG. 8 is a diagram illustrating an example of the service label.

FIG. 9 is a diagram illustrating a service label feature file.

FIG. 10 is a flowchart illustrating a routine of an information output process performed by the product code reader according to the first embodiment.

FIG. 11 is a flowchart illustrating a routine of a settlement process performed by the POS terminal.

FIG. 12 is a diagram illustrating an example of a display screen displayed on the POS terminal according to the first embodiment.

FIG. 13 is a block diagram illustrating a configuration of a POS terminal and a product code reader according to a second embodiment.

FIG. 14 is a diagram illustrating an example of a distribution type of a grade label.

FIG. 15 is a diagram illustrating a grade label feature file.

FIG. 16 is a flowchart illustrating a routine of an information output process performed by the product code reader according to the second embodiment.

FIG. 17 is a diagram illustrating an example of a display screen displayed on the product code reader according to the second embodiment.

FIG. 18 is a flowchart illustrating a routine of a settlement process performed by the POS terminal according to the second embodiment.

### DETAILED DESCRIPTION

A product information processing apparatus according to an embodiment includes: an image importing section; a service label detecting section; and a notifying section. The image importing section imports an image imaged by an imaging section. The service label detecting section detects a service label in which incentive content obtained from purchasing of the product is expressed in a visually unrecognizable form, from a product image imported by the image importing section. The notifying section notifies the incentive content of the service label detected by the service label detecting section.

Hereinafter, a product information processing apparatus and a program according to an embodiment will be described using a checkout system as an example. In this embodiment, a checkout system introduced to a store such as a restaurant or a supermarket will be described as an example.

### First Embodiment

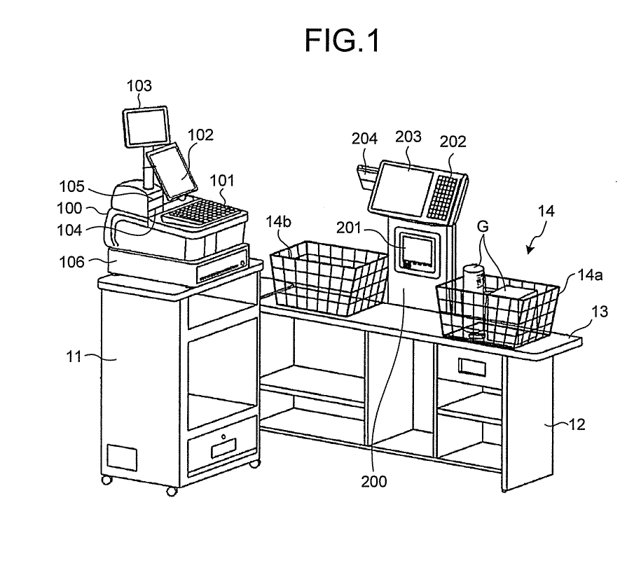

FIG. 1 is a perspective view schematically illustrating a configuration of a checkout system according to a first embodiment. As shown in FIG. 1, the checkout system includes a POS terminal 100 and a product code reader 200.

The POS terminal 100 is a product information processing apparatus which performs sale registration of products purchased by a customer, and is mounted on a checkout table 11. The POS terminal 100 includes a keyboard 101, an operator display 102, a customer display 103, a printer 104, a card reader 105, and a drawer 106. The respective sections included in the POS terminal 100 will be described later.

Further, a counter table 12 of a transversely long table shape is disposed to form an L shape with respect to the checkout table 11. On an upper surface of the counter table 12, a product placing surface 13 is formed. The product code reader 200 is mounted on the product placing surface 13 and is connected with the POS terminal 100 for communication in a wired or wireless manner.

The product code reader 200 detects a code symbol affixed to a product and outputs a product code retained in the code symbol to the POS terminal 100. As shown in FIG. 1, the product code reader 200 includes a reading window 201, a keyboard 202, an operator display 203, and a customer display 204. The respective sections included in the product code reader 200 will be described later.

A shopping basket 14 which accommodates a product G to which a code label or a service label which will be described later is affixed is placed on the product placing surface 13. The shopping basket 14 includes a first shopping basket 14a carried by a customer and a second shopping basket 14b placed on a position where the product code reader 200 is interposed between the first shopping basket 14a and the second shopping basket 14b.

In the first shopping basket 14a carried by the customer, the product G handled in one transaction is accommodated. A code label indicating a code symbol such as a barcode or a two-dimensional code, or a service label in which incentive content (for example, price discount) obtained under the condition of product purchasing is expressed in a visually unrecognizable form, is affixed to the product G. The product code relating to the product G is retained in the code symbol in a coded state. Here, the product code is a code allocated to each product for specifying the product G, and the JAN code is an example thereof.

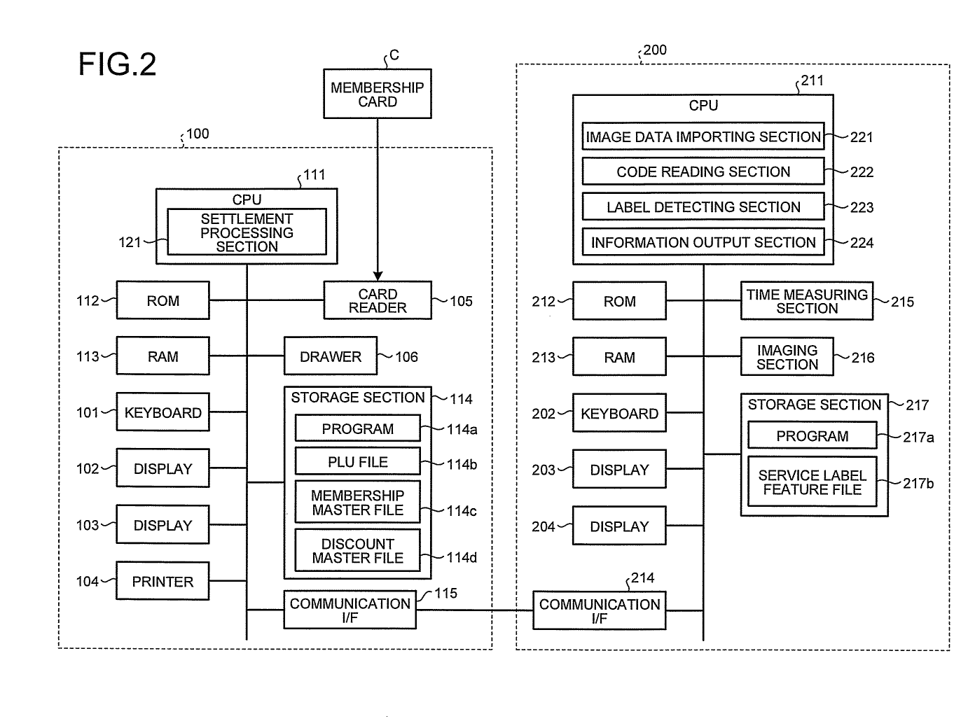

The product G in the first shopping basket 14a is moved to the second shopping basket 14b by an operator who operates the product code reader 200. In this movement process, the code label or the service label is directed to the reading window 201 of the product code reader 200. At this time, an imaging section 216 (see FIG. 2) which will be described later, installed in the reading window 201, images the code label or the service label affixed to the product.

The product code reader 200 detects a code symbol or a service label included in an image imaged by the imaging section 216. In this embodiment, an example in which a barcode is used as the code symbol is described. However, the embodiment is not limited thereto, but may use a two-dimensional code.

Hereinafter, a configuration of the checkout system will be described. FIG. 2 is a block diagram illustrating a configuration of the POS terminal 100 and the product code reader 200.

Firstly, the configuration of the POS terminal 100 will be described. The POS terminal 100 includes a CPU (Central Processing Unit) 111 which is a micro computer which performs information processing, a ROM (Read Only Memory) 112 and a RAM (Random Access Memory) 113.

The CPU 111 causes a variety of programs stored in the ROM 112 or a storage section 114 which will be described later to be executed, to thereby overall control the POS terminal 100. The ROM 112 stores a program for performing a basic operation. The RAM 113 is a main storage device of the POS terminal 100 and functions as a work area of the CPU 111.

Further, the keyboard 101, the display 102, the display 103, the printer 104, the card reader 105, and the drawer 106, as described above, are connected to the CPU 111, through a variety of input and output circuits (not shown).

The keyboard 101 is an input device which notifies the CPU 111 of information about keys (hereinafter, referred to as key information) input from the operator who operates the POS terminal 100. Avariety of operation keys such as a numerical keypad for inputting numerals or operators, or “sum” key necessary for settlement of a product price is provided in the keyboard 101.

The display 102 and the display 103 include a display device such as an LCD (Liquid Crystal Display), and display a variety of information such as a name of the product or a price thereof on the basis of an instruction of the CPU 111. Here, the display 102 is a display for an operator who operates the POS terminal 100, and its display surface is directed toward the operator (see FIG. 1). Further, the display 103 is a display for a customer, and its display surface is directed toward the customer (see FIG. 1). In this regard, as the display 102 is configured by a touch panel, all keys of the keyboard 101 or a part thereof may be realized on the touch panel.

The printer 104 is a printer such as a thermal printer, and prints a receipt or a log under the control of the CPU 111.

The card reader 105 is a reader which reads member identification information stored in a membership card C. Here, the membership card C is a card which is issued to the member and in which member identification information characteristic to an individual member is stored in a readable manner, and in this embodiment, is a magnetic card in which the member identification information is stored on a magnetic tape. The member identification information read from the membership card C by the card reader 105 is retained in the RAM 113 during one transaction under the control of the CPU 111.

The drawer 106 is a cash drawer which accommodates cash or the like, and is opened and closed under the control of the CPU 111.

Further, the storage section 114 and a communication I/F 115 are connected to the CPU 111 through a variety of input and output circuits (not shown).

The storage section 114 is a storage medium such as an HDD (Hard Disk Drive) or a flash memory, and stores a program 114a capable of being executed by the CPU 111 or a variety of files. As an example of the program 114a stored in the storage section 114, a program for a settlement process may be used. Further, as an example of the file stored in the storage section 114, a PLU (Price Look Up) file 114b, a membership master file 114c, a discount master file 114d, or the like may be used.

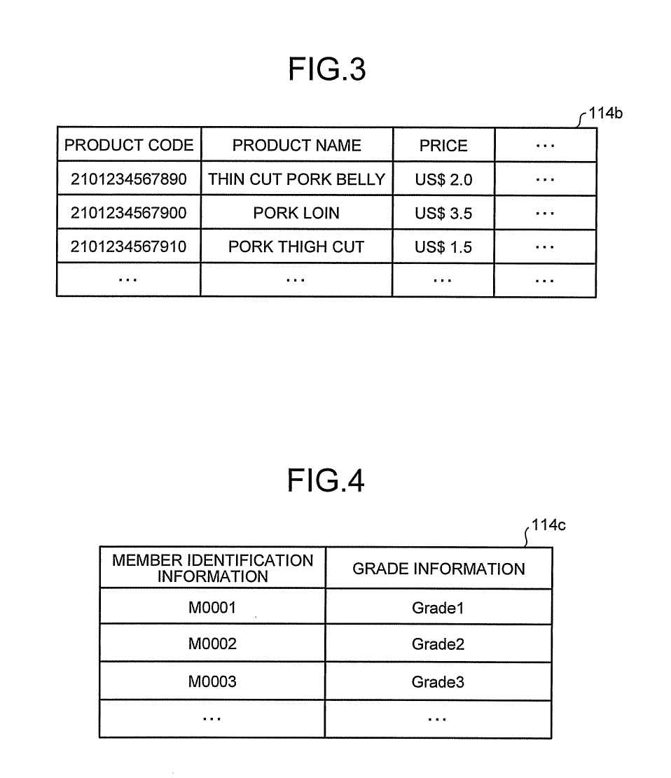

The PLU file 114b is a file for managing information relating to each product sold in a store. Specifically, a product code, a product name, a price thereof and the like which are uniquely allocated to each product are stored in the PLU file 114b to be matched with each other, for each product sold in a store. Here, FIG. 3 is a diagram illustrating an example of the PLU file 114b. As shown in the figure, a record in which a product code of each product, a name, a price thereof and the like are matched with each other is stored in the PLU file 114b.

The membership master file 114c is a file for managing member identification information about each member and grade information indicating the grade of the member to be matched with each other. Here, FIG. 4 is a diagram illustrating an example of the membership master file 114c. As shown in the same figure, a record in which the member identification information of each member and the grade information thereof are matched with each other is stored in the membership master file 114c. Here, each member is graded in advance on the basis of a predetermined reference such as a store usage frequency or a total amount of payment. In the figure, an example in which three grades are given as the grade information is shown, and the grades are set to be descended in the order of Grade 1, Grade 2 and Grade 3. The information stored in the membership master file 114c is not limited to the example shown in FIG. 4. For example, individual information such as a name, age or address of the member, or an accumulated point value assigned to each member, may be stored.

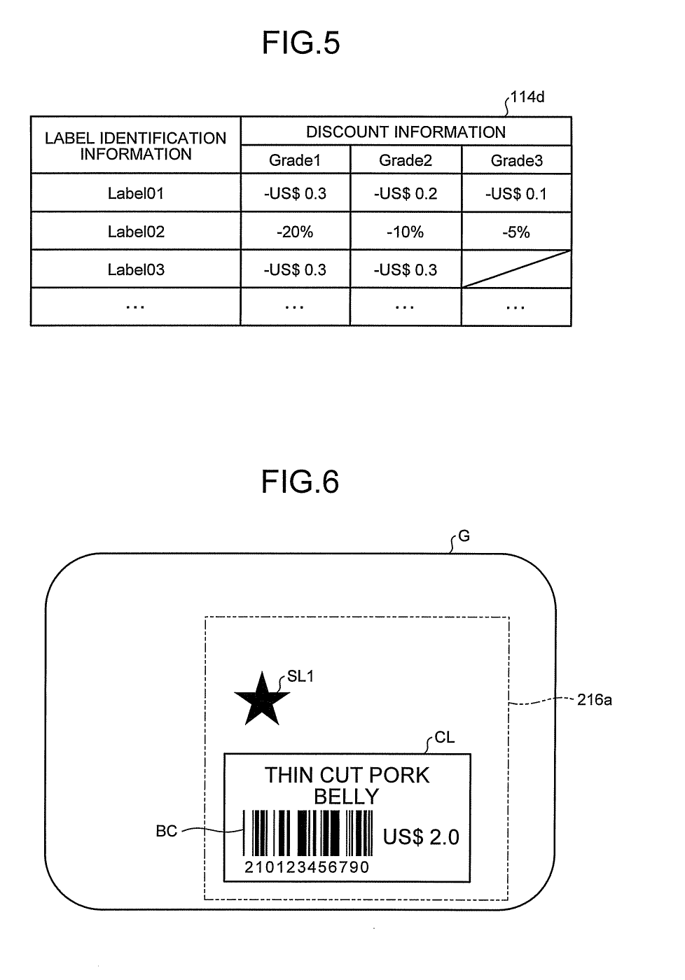

The discount master file 114d is a file for managing a discount amount according to the grade of each member. Here, FIG. 5 is a diagram illustrating an example of the discount master file 114d. As shown in the figure, each set of label identification information to be described later and information indicating the discount amount for each set of grade information according to the label identification information are stored in the discount master file 114d to be matched with each other. In the discount information, information obtained by converting discount money or discount rate into an English and numerical value capable of being identified by the CPU 111 of the POS terminal 100 is stored. For example, “US $ −0.30” indicate that US $0.30 are to be discounted from the price of the product, and “−20%” indicates that 20% of the price of the product is discounted.

Returning to FIG. 2, the communication I/F (interface) 115 is an interface for performing data communication with the product code reader 200. The CPU 111 transmits or receives various data to or from the product code reader 200 through the communication I/F 115.

Further, the CPU 111 of the POS terminal 100 operates a settlement processing section 121, in cooperation with the program stored in the ROM 112 or the storage section 114, as shown in FIG. 2.

When an input of the product code is received from the product code reader 200, the settlement processing section 121 reads a record corresponding to the product code from the PLU file 114b, and performs sale registration as a settlement target product. Here, the sale registration is for storing the record of each product read from the PLU file 114b in the RAM 113 in relation to the number of purchases of the product.

Further, when an input of the label identification information which will be described later is received from the product code reader 200, the settlement processing section 121 reads the grade information corresponding to the member identification information read from the membership card C by the card reader 105, from the membership master file 114c, and then reads discount information corresponding to the set of the grade information and the input label identification information from the discount master file 114d. Further, when the discount amount according to the discount information is discounted from the product price, the settlement processing section 121 performs the sale registration using the record after discount.

Further, the settlement processing section 121 calculates the total purchase price of all products from the price of each product which is sale-registered and the number of sales according to the input of the “sum” key of the keyboard 101, and displays the result on the displays 102 and 103 using content of the sale-registered record as transaction content, or outputs a receipt through the printer 104.

Next, the configuration of the product code reader 200 will be described. As shown in FIG. 2, the product code reader 200 includes a CPU 211, a ROM 212 and a RAM 213.

The CPU 211 causes a variety of programs stored in the ROM 212 to be executed, to thereby control the product code reader 200. The ROM 212 stores a program for performing a basic operation. The RAM 213 is a main storage device of the product code reader 200, and functions as a work area of the CPU 211.

Further, the keyboard 202, the display 203, and the display 204 are connected to the CPU 211, through a variety of input and output circuits (not shown).

The keyboard 202 is an input device which notifies the CPU 211 of key information input from the operator who operates the product code reader 200. The keyboard 202 is used for input of the number of sales, input of the product code of a product of which the barcode is difficult to read, or the like.

The display 203 and the display 204 include a display device such as an LCD, and display a variety of information such as a name or price of the product on the basis of an instruction of the CPU 211. Here, the display 203 is a display for an operator who operates the product code reader 200, and its display surface is directed toward the operator (see FIG. 1). Further, the display 204 is a display for a customer, and its display surface is directed toward the customer (see FIG. 1). Here, as the display 203 is configured by a touch panel, all keys of the keyboard 202 or a part thereof may be realized on the touch panel.

Further, a communication I/F 214, a time measuring section 215, the imaging section 216 and a storage section 217 are connected to the CPU 211, through a variety of input and output circuits (not shown).

The communication I/F 214 is an interface for performing data communication with the POS terminal 100. The CPU 211 transmits or receives various data to or from the POS terminal 100 through the communication I/F 214. The time measuring section 215 is a time measuring device such as an RTC, and outputs a current date and time to the CPU 211.

The imaging section 216 is an image sensor such as a CCD (Charge Coupled Device) or a CMOS (Complementary Metal Oxide Semiconductor), and is installed in the reading window 201 shown in FIG. 1. Further, the imaging section 216 starts or stops imaging under the control of the CPU 211.

Hereinafter, the relationship between an imaged area of the imaging section 216 and the product G thereof will be described with reference to FIG. 6. FIG. 6 is a diagram illustrating an example of the relationship between the imaged area of the imaging section 216 and the product G. An area surrounded by a dashed line is an imaging area 216a which is an area which can be imaged by the imaging section 216 with one frame. Here, a code label CL and a service label SL1 are affixed to the product G.

A barcode BC or the like which is a code symbol, in addition to a product name “thin cut pork belly” or a product price “US $2.00”, is expressed in the code label CL. Under the barcode BC, numerals of the product code included in the barcode BC “2101234567890” are expressed.

Further, the service label SL1 is a label indicating a predetermined symbol or color. Here, the service label SL1 is affixed for clarifying the fact that the product is a discount target to a customer, but since the incentive content is expressed in a visually unrecognizable form, the customer cannot directly recognize the incentive content.

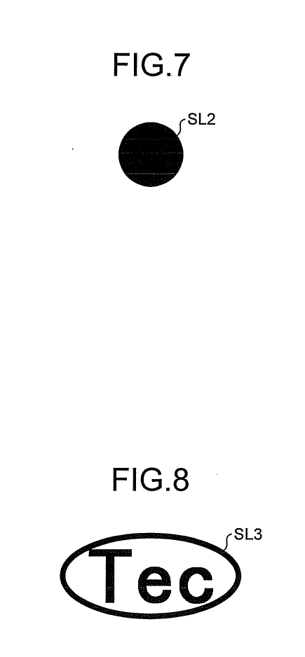

A star shaped service label SL1 is shown in FIG. 6 as an example in which the service label is expressed as a graphic symbol, but a circular service label SL2 may be used as shown in FIG. 7. Further, as shown in FIG. 8, a logo type or the like may be used as a service label SL3. In this case, the logo type which is the service label SL3 may be used in the state of being printed in advance on a packaging of the product G. Further, for example, a mark (trademark) of a company which manufactures and sells the product G or a mark (trademark) indicating a specific product name may be used as the service label SL3.

Returning to FIG. 2, the storage section 217 is a recording medium such as an HDD or a flash memory, and stores a program 217a capable of being executed by the CPU 211 or a variety of files. Here, as an example of the program 217a stored in the storing section 217, a program for controlling the imaging section 216, a program for code symbol reading, a program for image or character recognition such as OCR (Optical Character Reader) or pattern matching, or the like may be used. Further, as an example of the file stored in the storage section 217, a service label feature file 217b or the like may be used.

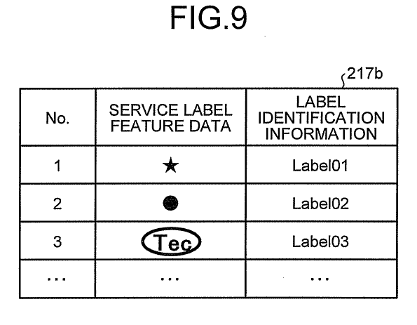

The service label feature file 217b is a file which manages a feature of each set of service label and label identification information for identifying the service label to be matched. FIG. 9 is a diagram illustrating the service label feature file 217b. As shown in the figure, the service label feature file 217b stores service label feature data indicating a feature such as a shape (raster data, vector data) or color of a service label and label identification information which is named in advance for identification of the corresponding service label to be matched.

Here, the service label feature data is used for detecting an image of the service label from the image data imaged by the imaging section 216, by pattern matching, OCR, color identification process or the like. For example, in the service label feature file 217b in FIG. 9, when the star shaped service label SL1 shown in FIG. 6 is detected from the image data imaged by the imaging section 216 on the basis of service label feature data of No. 1, “Labe101” is specified as the label identification information of the service label SL1.

Next, a characteristic function included in the product code reader 200 will be described. The CPU 211 operates an image data importing section 221, a code reading section 222, a label detecting section 223, and an information output section 224, in cooperation with a program stored in the ROM 212 or the storage section 217, as shown in FIG. 2.

The image data importing section 221 outputs an imaging ON signal to the imaging section 216, to thereby allow the imaging section 216 to start the imaging operation. The image data importing section 221 imports the image data in the imaged area 216a which is imaged by the imaging section 216, and then stores the result in the RAM 213. Further, when an instruction is received from the label detecting section 223, the image data importing section 221 imports the image data in the imaged area 216a which is imaged by the imaging section 216, and then stores the result to the RAM 213.

The code reading section 222 performs a barcode reading process of detecting an image of a barcode from the image data stored in the RAM 213 by the image data importing section 221, and of reading a product code from the detected barcode. Specifically, the code reading section 222 binarizes image data of one frame stored in the RAM 213, and detects whether a data region relating to the barcode is present in the binarized data. When the data region relating to the barcode is detected, the code reading section 222 decodes the barcode and reads the decoded data as a product code of the product G. Further, the code reading section 222 stores the read product code in the RAM 213.

The label detecting section 223 performs a service label detection process of detecting an image of a service label from the image data of one frame stored in the image work area of the RAM 213 by the image data importing section 221. In the service label detection process, the label detecting section 223 compares the feature of the service label included in the image data by pattern matching, OCR character recognition or the like with each set of service label feature data (see FIG. 9) registered in the service label feature file 217b. If the feature coincides with any service label feature data or is similar thereto, the label detecting section 223 determines that the service label is detected. Further, the label detecting section 223 reads the label identification information corresponding to the coincided service label feature data, and then stores the result in the RAM 213.

Further, the label detecting section 223 limits the time when the service label detection process is performed on the basis of the time measured by the time measuring section 215. Specifically, when performing the service label detection process, the label detecting section 223 starts to measure a time-out time which becomes the performance time of the label reading process (for example, 5 seconds or the like) on the basis of the time measured by the time measuring section 215. Further, even when the service label is not detected, the label detecting section 223 also continuously performs the label reading process until it becomes the time-out time, and instructs the image data importing section 221 to perform image importing, so as to perform a process of newly importing the image data in the imaging area 216a which is imaged by the imaging section 216. In this way, an operator of the product code reader 200 can image the product Gby the imaging section 216 over a plurality of times, for a predetermined time when the service label reading process is performed.

The information output section 224 transmits (outputs) the product code read by the code reading section 222 and the label identification information read by the label detecting section 223 to the POS terminal 100 through the communication I/F 214. Specifically, when the information stored in the RAM 213 is only the product code, the information output section 224 transmits the product code to the POS terminal 100. Further, when the product code and the label identification information are stored in the RAM 213, the information output section 224 transmits the product code and the label identification information to the POS terminal 100.

For example, as shown in FIG. 6, when the star shaped service label SL1 is affixed to the product G, the label detecting section 223 stores the label identification information “Labe101” of the service label SL1 in the RAM 213. Accordingly, the information output section 224 transmits a set of the product code indicating “210234567890” and the label identification information indicating “Labe101” to the POS terminal 100.

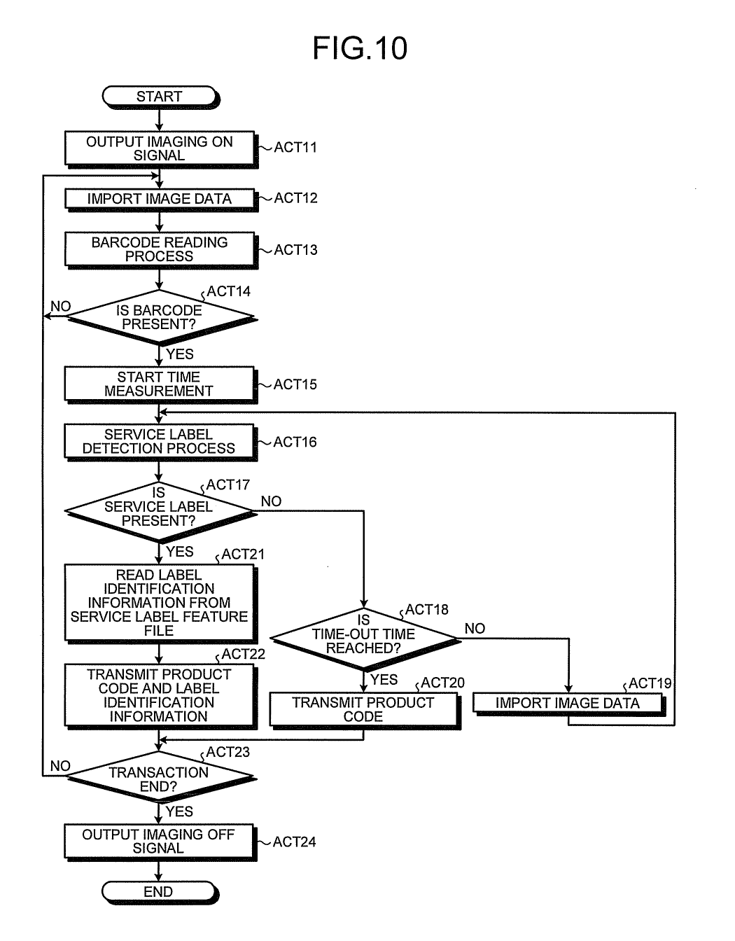

Next, an operation of the checkout system according to the present embodiment will be described with reference to FIGS. 10 to 12. Here, FIG. 10 is a flowchart illustrating a routine of an information output process performed by the product code reader 200.

If transaction start is instructed by a predetermined signal from the POS terminal 100, the CPU 211 of the product code reader 200 starts an information output process. The image data importing section 221 outputs an imaging ON signal to the imaging section 216, to thereby allow the imaging section 216 to start the imaging operation (ACT 11). The image data importing section 221 imports the image data imaged by the imaging section 216 in the RAM 213 (ACT 12). Further, the code reading section 222 starts the above-described barcode reading process (ACT 13).

The code reading section 222 determines whether a barcode is detected in the barcode reading process of ACT 13 (ACT 14). Here, if the barcode cannot be detected (No in ACT 14), the routine returns to ACT 12 again, and then the code reading section 222 performs the barcode reading process for image data which is newly imported.

If the barcode is detected (Yes in ACT 14), the label detecting section 223 starts to measure a time-out time on the basis of the time, measured by the time measuring section 215 (ACT 15). Subsequently, the label detecting section 223 starts the service label detection process for the image data imported in the RAM 213 in ACT 12 (ACT 16). Further, the label detecting section 223 determines whether the service label is detected in the service label detection process of ACT 16 (ACT 17).

Here, if the service label cannot be detected (No in ACT 17), the label detecting section 223 determines whether it becomes the time-out time (ACT 18). If it does not become the time-out time (No in ACT 18), the label detecting section 223 controls the image data importing section 221 to newly perform image data importing (ACT 19). Then, the routine returns to ACT 16, and the label detecting section 223 performs the service label reading process for the image data which is newly imported.

Further, if the label detecting section 223 determines that it becomes the time-out time (Yes in ACT 18), the information output section 224 transmits the product code stored in the RAM 213 in the barcode reading process of ACT 13 to the POS terminal 100 through the communication I/F 214 (ACT 20), and then the routine proceeds to ACT 23.

Further, if the service label is detected before it becomes the time-out time (Yes in ACT 17), the label detecting section 223 reads the label identification information corresponding to the service label from the service label feature file 217b, and then stores the result in the RAM 213 (ACT 21). Then, the information output section 224 transmits the label identification information stored in the RAM 213 in ACT 21 together with the product code stored in the RAM 213 in the barcode reading process of ACT 13 to the POS terminal 100 through the communication I/F 214 (ACT 22), and then the routine proceeds to ACT 23.

In ACT 23, the CPU 211 determines whether transaction end is instructed by a predetermined signal from the POS terminal 100 (ACT 23). If the transaction end is not instructed (No in ACT 23), the routine returns to ACT 12 again. Then, the operations of the ACTs 12 to 23 are repeated until the sale registration of all the products is completed. Further, if the transaction end is instructed (Yes in ACT 23), the image data importing section 221 outputs an imaging OFF signal to the imaging section 216, to thereby stop the imaging operation of the imaging section 216 (ACT 24). Then, this process is terminated.

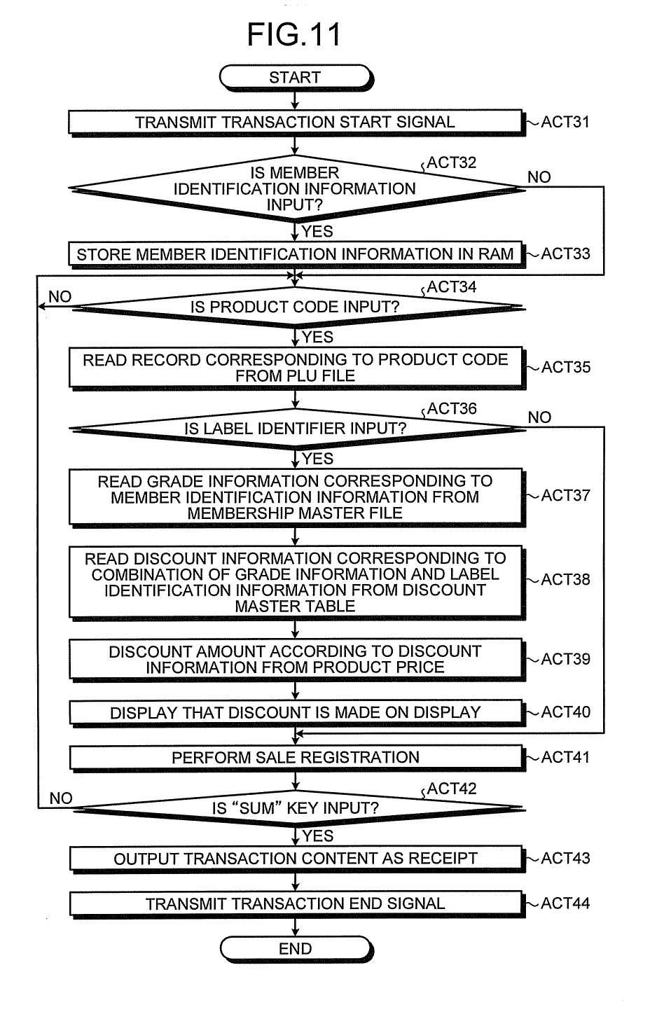

Next, a settlement process performed by the POS terminal 100 will be described with reference to FIG. 11. Here, FIG. 11 is a flowchart illustrating a routine of the settlement process performed by the POS terminal 100.

Firstly, the CPU 111 of the POS terminal 100 transmits a signal indicating the transaction start to the product code reader 200 according to a predetermined key operation of the keyboard 101 (ACT 31). Subsequently, the settlement processing section 121 determines whether the member identification information is input through the card reader 105 (ACT 32). Here, if it is confirmed that the member identification information is input (Yes in ACT 32), the settlement processing section 121 stores the member identification information in the RAM 113 (ACT 33), and then the routine proceeds to ACT 34. If it cannot be confirmed that the member identification information is input, the routine directly proceeds to Act 34.

In ACT 34, the settlement processing section 121 waits until the product code is input from the product code reader 200 (No in ACT 34). If the settlement processing section 121 receives the input of the product code (Yes in ACT 34), the settlement processing section 121 reads a record corresponding to the product code from the PLU file 114b (ACT 35).

Then, the settlement processing section 121 determines whether an input of the label identification information is received together with the input of the product code in ACT 34 (ACT 36). Here, if the input of the label identification information cannot be confirmed (No in ACT 36), the settlement processing section 121 performs the sale registration on the basis of the record read in ACT 35 (ACT 41), and then the routine proceeds to ACT 42.

Further, in ACT 36, if it is determined that the input of the label identification information is received (Yes in ACT 36), the settlement processing section 121 reads the grade information corresponding to the member identification information retained in the RAM 113 from the membership master file 114c (ACT 37). Then, the settlement processing section 121 reads discount information corresponding to a combination of the grade information read in ACT 37 and the label identification information received in ACT 36 from the discount master file 114d (ACT 38).

Subsequently, if a discount is made from the product price included in the record read in ACT 35, on the basis of the discount information read in ACT 38 (ACT 39), the settlement processing section 121 displays the fact that the discount is made on the display 102 (ACT 40). Further, the settlement processing section 121 performs the sale registration on the basis of the record after discount (Act 41), and then the routine proceeds to ACT 42.

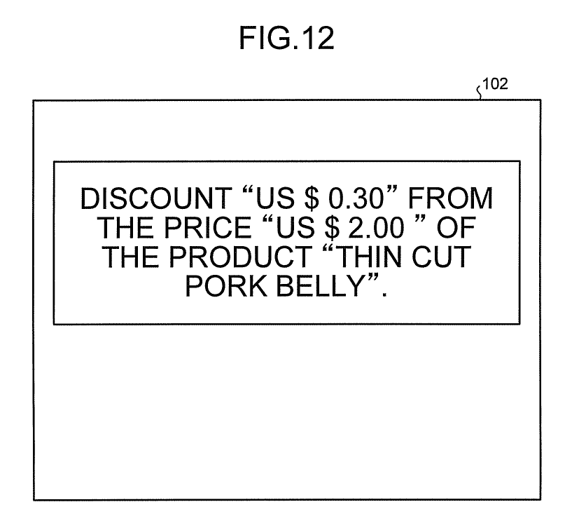

Here, FIG. 12 is a diagram illustrating an example of a screen displayed on the display 102 in ACT 40. In the figure, an example is shown in which a combination of the information (product name “thin cut pork belly” and price “US $2.00”) included in the record read in ACT 35 and a discount amount “US $0.30” is displayed. Thus, whenever a discount according to a service label (label identification information) occurs, since the fact that the discount occurs can be notified to the operator of the POS terminal 100, the operator can recognize that the discount is made. Such a display may be performed on the customer display 103, and in this case, the customer (member) can recognize the occurrence of the discount according to the service label (label identification information).

In ACT 42, the CPU 111 determines whether an input of the key information indicating the “sum” key through the keyboard 101 is received (ACT 42). Here, if the sum key input cannot be confirmed (No in ACT 42), the routine returns to ACT 34 again, and the settlement processing section 121 waits for an input of a new product code. Further, in ACT 42, if the input of the “sum” key is received (Yes in ACT 42), the settlement processing section 121 causes the printer 104 to print the data content which is sale-registered, to thereby output the transaction content corresponding to one transaction as a receipt (ACT 43). Further, the CPU 111 transmits a signal instructing transaction end to the product code reader 200 through the communication I/F 115 (ACT 44). Then, this process is terminated.

As described above, according to the present embodiment, it is possible to provide the discount service according to the grade of each member without making a customer (member) aware of the discount amount, thereby making it possible to increase the number of shopping occasions of the member to promote sales, from the standpoint of the store.

In this embodiment, the input determination of the member identification information is performed directly after the transaction start as shown in FIG. 11, but the embodiment is not limitative. For example, when the member identification information is input after the “sum” key is input, a discount amount (discount information) according to the set of the label identification information and the grade information of the member identification information is discounted from the price of each product (product code) in which the label identification information is input.

### Second Embodiment

Next, a second embodiment will be described. In this embodiment, similarly to the service label, the grade of a customer may be determined on the basis of a predetermined label, and a service according to the grade may be provided. The same reference numerals are given to the same components as in the first embodiment, and its description will be omitted.

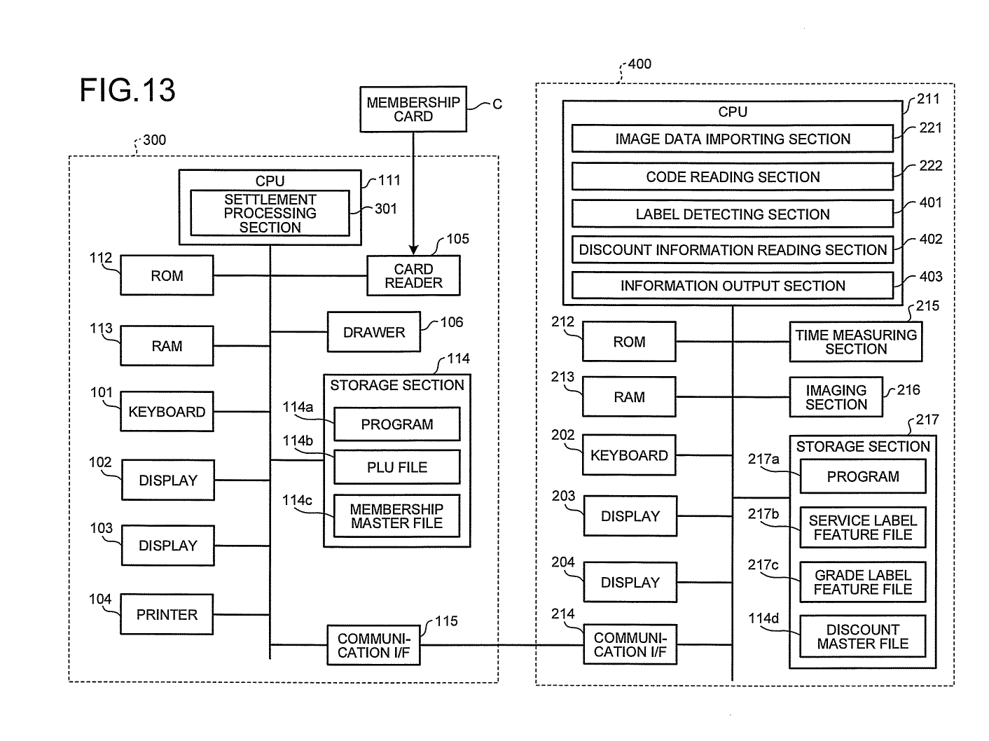

FIG. 13 is a block diagram illustrating a configuration of a POS terminal 300 and a product code reader 400 according to the second embodiment. The arrangement relationship between the POS terminal 300 and the product code reader 400 is the same as in the first embodiment shown in FIG. 1.

As shown in FIG. 13, the POS terminal 300 includes the same hardware configuration as that of the above-described POS terminal 100. Here, the storage section 114 stores the program 114a, the PLU file 114b and the membership master file 114c. In this embodiment, since the member identification information is not used, the card reader 105 and the membership master file 114c relating to the member identification information may be omitted.

The CPU 111 of the POS terminal 300 operates a settlement processing section 301 which is a characteristic functional section according to the present embodiment, in cooperation with the program stored in the ROM 112 or the storage section 114.

A settlement processing section 301 has the same function as that of the settlement processing section 121. Further, the settlement processing section 301 receives an input of discount information from the product code reader 400, and discounts a discount amount according to the discount information from the price (product price) in a record read from the PLU file 114b, as a characteristic function according to the present embodiment.

The product code reader 400 includes the same hardware configuration as that of the product code reader 200. Here, the storage section 217 stores a grade label feature file 217c in addition to the program 217a and the service label feature file 217b, and the discount master file 114d. In this embodiment, the discount master file 114d is stored in the storage section 217, but the embodiment is not limitative. For example, when the POS terminal 300 stores the discount master file 114d, the product code reader 400 may refer to the discount master file 114d through the communication I/F 214.

The grade label feature file 217c is a file which stores a feature of the grade label and grade information of the grade label to be matched. Here, the grade label is a label in which the grade of the member is expressed in a visually unrecognizable form using a graphic symbol such as a predetermined symbol or color. It is assumed that the grade label according to the grade of each member is distributed in advance in the form of DM (direct mail) or the like.

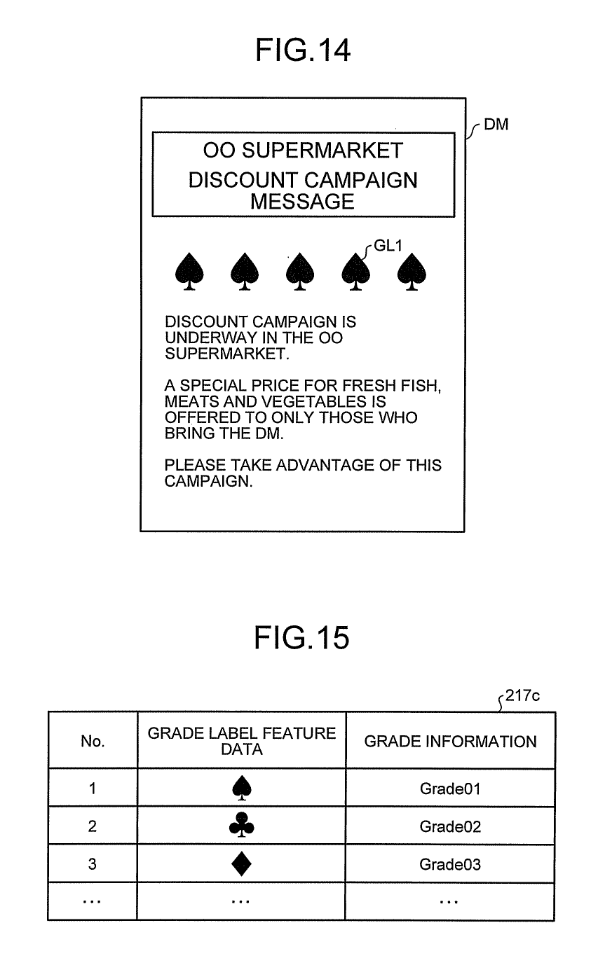

FIG. 14 is a diagram illustrating an example of a distribution type of the grade label. Here, FIG. 14 illustrates an example of the DM distributed to each member, in which a spade shaped symbol GL1 corresponds to the grade label. The grade label according to the grade of a member who is a distribution target of the DM is affixed to the DM, and the member who receives the DM gives the DM to an operator of the product code reader 400 in product settlement, to thereby image the grade label. In this embodiment, the grade label is distributed to each member using DM, but the embodiment is not limitative. For example, an image of the grade label may be distributed using e-mail or the like.

The type of the grade label distributed to each member and its grade information are defined in the grade label feature file 217c. Here, FIG. 15 is a diagram illustrating the grade label feature file 217c. As shown in the figure, the grade label feature file 217c stores grade label feature data indicating a feature such as a shape (raster data, vector data) or color of a grade label and grade information which is allocated to the grade label to be matched.

The grade label feature data is used for detecting an image of the grade label from the image data imaged by the imaging section 216, by pattern matching, OCR, color identification process or the like, in a similar way to the above-described service label feature data. For example, in the grade label feature file 217c in FIG. 15, when the spade shaped grade label GL1 shown in FIG. 14 is detected from the image data imaged by the imaging section 216 on the basis of grade label feature data of No. 1, “Grade01” is specified as the grade information of the grade label GL1.

Further, the CPU 211 of the product code reader 400 operates the above-described image data importing section 221 and the code reading section 222, in cooperation with a program stored in the ROM 212 or the storage section 217, and also operates a label detecting section 401, a discount information reading section 402 and an information output section 403 which are characteristic functional sections according to this embodiment.

The label detecting section 401 has the same function as the above-described label detecting section 223. Further, the label detecting section 401 performs a grade label detection process of detecting an image of a grade label from the image data of one frame stored in the image work area of the RAM 213 by the image data importing section 221, as a characteristic function according to this embodiment. In the grade label detection process, the label detecting section 401 compares the feature of the grade label included in the image data by pattern matching, OCR character recognition or the like with each set of grade label feature data (see FIG. 15) registered in the grade label feature file 217c, in a similar way to the service label detection process. If the feature coincides with any grade label feature data, the label detecting section 401 determines that the service label is detected. Further, the label detecting section 401 reads the grade information corresponding to the coinciding grade label feature data, and then stores the result in the RAM 213.

The discount information reading section 402 reads the discount information corresponding to a combination of the grade information stored in the RAM 213 by the label detecting section 401 and the label identification information from the discount master file 114d of the storage section 217, and then stores the result in the RAM 213. Further, the discount information reading section 402 displays a message of the fact that the discount is made on the display 203 on the basis of the discount information read from the discount master file 114d.

The information output section 403 transmits (outputs) the product code read by the code reading section 222 and the discount information read by the discount information detecting section 402 to the POS terminal 300 through the communication I/F 214. Specifically, when the information stored in the RAM 213 is only the product code, the information output section 403 transmits the product code to the POS terminal 300. Further, when the product code and the discount information are stored in the RAM 213, the information output section 403 transmits the product code and the discount information to the POS terminal 300.

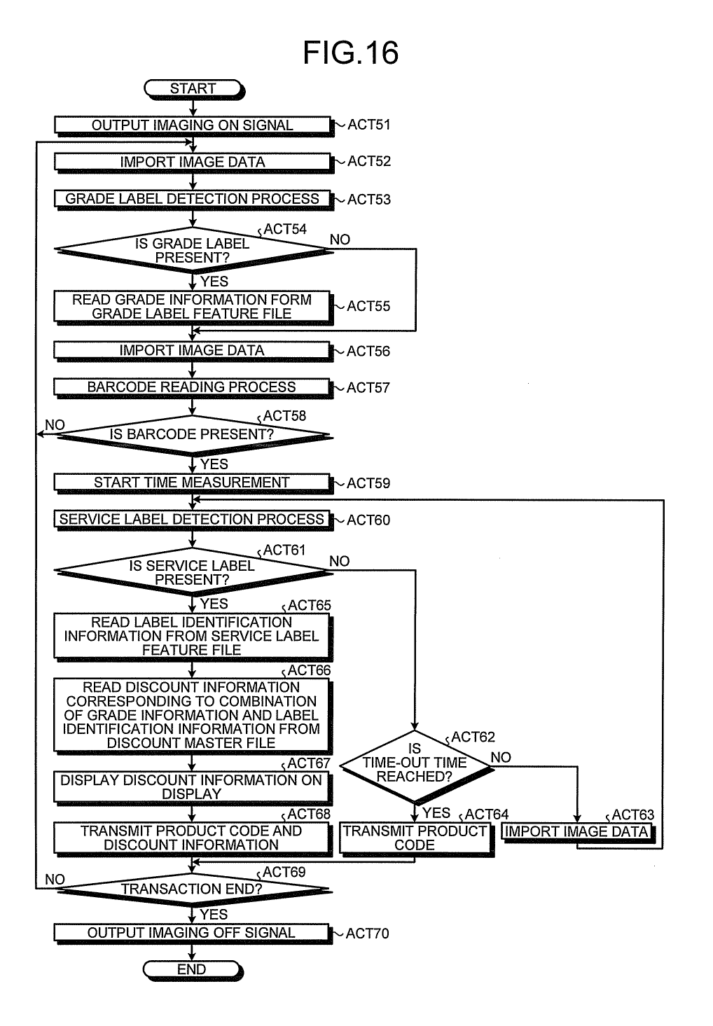

Hereinafter, an operation of the checkout system according to this embodiment will be described with reference to FIGS. 16 to 18. Here, FIG. 16 is a flowchart illustrating a routine of an information output process performed by the product code reader 400.

If transaction start is instructed by a predetermined signal from the POS terminal 300, the CPU 211 of the product code reader 400 starts an information output process. The image data importing section 221 outputs an imaging ON signal to the imaging section 216, to thereby allow the imaging section 216 to start the imaging operation (ACT 51). The image data importing section 221 imports the image data imaged by the imaging section 216 in the RAM 213 (ACT 52).

Then, the label detecting section 401 starts a grade label detection process (ACT 53), and determines whether the grade label is detected in the image data (ACT 54). If the grade label is detected (Yes in ACT 54), the label detecting section 401 reads the grade information corresponding to the grade label from the grade label feature file 217c, and stores the result in the RAM 213 (ACT 55). Then, the routine proceeds to ACT 56. If the grade label cannot be detected (No in ACT 54), the routine directly proceeds to ACT 56.

Further, the code reading section 222 controls the image data importing section 221 to newly perform image data importing (ACT 56), and starts a barcode reading process (ACT 57). Subsequently, the code reading section 222 determines whether a barcode is detected in the barcode reading process of ACT 57 (ACT 58). Here, if the barcode cannot be detected (No in ACT 58), the routine returns to ACT 52 again.

Further, if the code reading section 222 detects the barcode (Yes in ACT 58), the label detecting section 401 starts to measure a time-out time on the basis of the time measured by the time measuring section 215 (ACT 59). Subsequently, the label detecting section 401 starts the service label detection process for the image data imported in the RAM 213 in ACT 56 (ACT 60). Further, the label detecting section 401 determines whether the service label is detected in the service label detection process of ACT 60 (ACT 61).

Here, if the service label cannot be detected (No in ACT 61), the label detecting section 401 determines whether it becomes the time-out time (ACT 62). If it does not become the time-out time (No in ACT 62), the label detecting section 401 controls the image data importing section 221 to newly perform image data importing (ACT 63). Then, the routine returns to ACT 60, and the label detecting section 401 performs the service label reading process for the image data which is newly imported.

Further, if the label detecting section 401 determines that it becomes the time-out time (Yes in ACT 62), the information output section 403 transmits the product code stored in the RAM 213 in the barcode reading process of ACT 57 to the POS terminal 300 through the communication I/F 214 (ACT 64), and then the routine proceeds to ACT 69.

Further, if the service label is detected before it becomes the time-out time (Yes in ACT 61), the label detecting section 401 reads the label identification information corresponding to the service label from the service label feature file 217b, and then stores the result in the RAM 213 (ACT 65). Then, the discount information reading section 402 reads the discount information corresponding to a combination of the grade information stored in the RAM 213 in ACT 55 and the label identification information stored in the RAM 213 in ACT 65, from the discount master file 114d, and then stores the result in the RAM 213 (ACT 66). Further, the discount information reading section 402 displays a message of the fact that the discount is made on the display 203 on the basis of the read discount information (ACT 67).

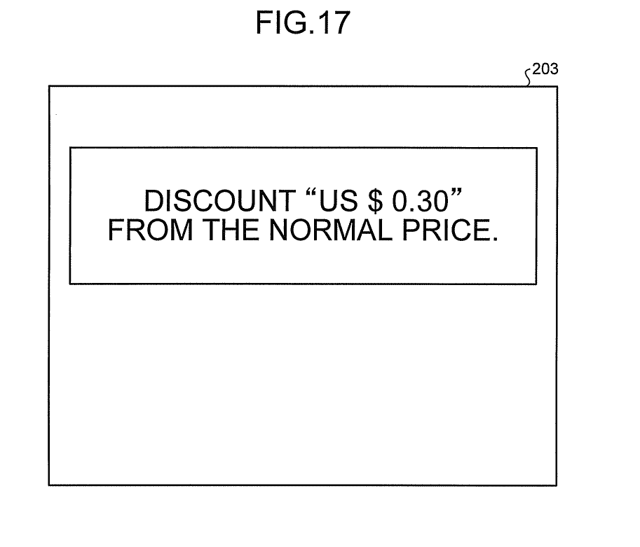

Here, FIG. 17 is a diagram illustrating an example of a screen displayed on the display 203 in ACT 67. In the figure, a discount amount (US $0.30) included in the discount information read in ACT 66 is discounted from a normal price. Thus, whenever a discount according to a service label (label identification information) occurs, since the fact that the discount occurs can be notified to the operator of the product code reader 400, the operator can recognize that the product is a discount target. Such a display may be performed on the customer display 204, and in this case, the customer (member) can recognize the occurrence of the discount according to the service label (label identification information).

Returning to FIG. 16, the information output section 403 transmits the discount information stored in the RAM 213 in ACT 66 and the product code stored in the RAM 213 in the barcode reading process of ACT 57 to the POS terminal 300 through the communication I/F 214 (ACT 68), and then the routine proceeds to ACT 69. If the discount information corresponding to a combination of the grade information and the label identification information is not present (for example, a case where detection of the grade label is not performed, or the like), the operations of ACTs 66 and 67 are skipped, and only the product code is transmitted in ACT 68.

In ACT 69, the CPU 211 determines whether transaction end is instructed by a predetermined signal from the POS terminal 300 (ACT 69). If the transaction end is not instructed (No in ACT 69), the routine returns to ACT 52 again. Then, the operations of the ACTs 52 to 69 are repeated until the sale registration of all the products is completed. Further, if the transaction end is instructed (Yes in ACT 69), the image data importing section 221 outputs an imaging OFF signal to the imaging section 216, to thereby stop the imaging operation of the imaging section 216 (ACT 70). Then, this process is terminated.

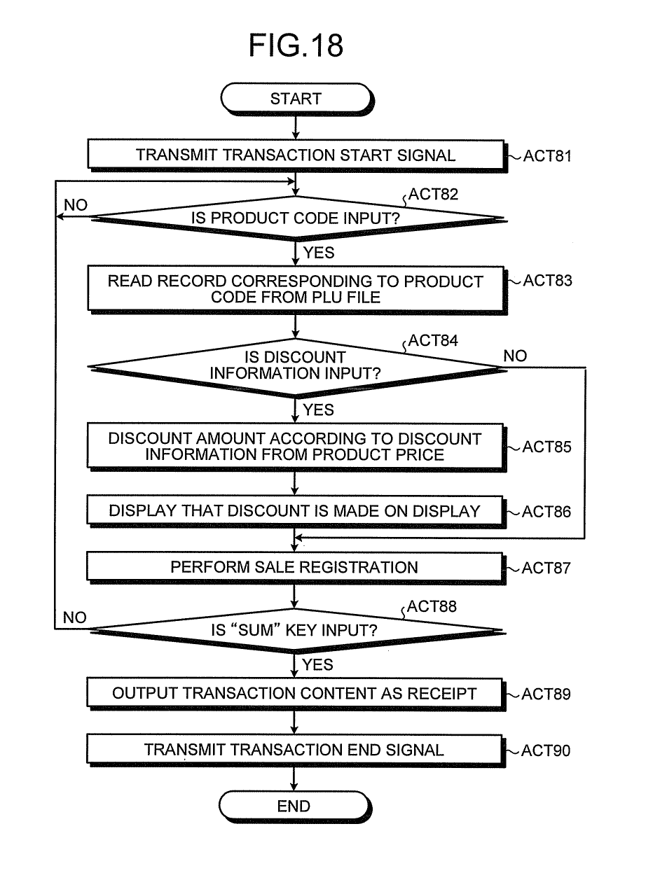

Next, a settlement process performed by the POS terminal 300 will be described with reference to FIG. 18. Here, FIG. 18 is a flowchart illustrating a routine of the settlement process performed by the POS terminal 300.

Firstly, the CPU 111 of the POS terminal 300 transmits a signal indicating the transaction start to the product code reader 400 according to a predetermined key operation of the keyboard 101 (ACT 81). Subsequently, the settlement processing section 301 waits until the product code is input from the product code reader 400 (No in ACT 82). If the settlement processing section 301 receives the input of the product code (Yes in ACT 82), the settlement processing section 301 reads a record corresponding to the product code from the PLU file 114b (ACT 83).

Thereafter, the settlement processing section 301 determines whether an input of the discount information is received together with the input of the product code in ACT 82 (ACT 84). Here, if the input of the discount information cannot be confirmed (No in ACT 84), the settlement processing section 301 performs the sale registration on the basis of the record read in ACT 83 (ACT 87), and then the routine proceeds to ACT 88.

Further, if it is determined in ACT 84 that the input of the discount information is received (Yes in ACT 84), when a discount amount according to the discount information is discounted from the product price included in the record read in ACT 83 (ACT 85), the settlement processing section 301 displays the fact that the discount is made on the display 102 (ACT 86), as shown in FIG. 12. Further, the settlement processing section 301 performs the sale registration on the basis of the record after discount (ACT 87), and then the routine proceeds to ACT 88.

In ACT 88, the CPU 111 determines whether an input of the key information indicating the “sum” key through the keyboard 101 is received (ACT 88). Here, if the “sum” key input cannot be confirmed (No in ACT 88), the routine proceeds to ACT 82 again, and the settlement processing section 301 waits for an input of a new product code. Further, in ACT 88, if the input of the “sum” key is received (Yes in ACT 88), the settlement processing section 301 causes the printer 104 to print the data content which is sale-registered, to thereby output the transaction content corresponding to one transaction as a receipt (ACT 89). Further, the CPU 111 transmits a signal instructing the transaction end to the product code reader 400 through the communication I/F 115 (ACT 90). Then, this process is terminated.

As described above, according to the present embodiment, it is possible to provide the discount service according to the grade of each member without making a customer (member) aware of the discount amount, thereby making it possible to increase the number of shopping occasions of the member to promote sales, from the standpoint of the store. Further, the product code reader 400 can detect a grade label from the image data imaged by the imaging section 216 and can calculate the discount amount according to the grade information. Thus, since the product code reader 400 can calculate the discount amount, it is possible to provide a discount service according to the grade of each member without using a membership card.

In the embodiments, the grade label according to each member is distributed by the DM and the grade label affixed to the DM is imaged, and thus, the grade of each member is specified. However, the usage form of the grade label is not limited thereto. For example, an adhesive may be coated on a rear surface of the grade label, and a grade label may be distributed in such a seal form that the grade label is temporarily affixed to a release paper treated so that the adhesive is not completely attached thereto, so that a customer can affix the distributed grade label to the product which is the discount target to which the service label is affixed. In this case, the operations of the ACTs 54 and 55 described in FIG. 16 are performed after ACT 58 (for example, between ACT 58 and ACT 59), it is possible to detect the service label and the grade label from the same image data.

Hereinbefore, the embodiments were described, but the embodiments are not limitative. A variety of modifications, substitutions, additions or the like are possible in a range without departing from the scope of the invention.

For example, in the above embodiments, the PLU file 114b, the member master file 114c, and the discount master file 114d are stored in the POS terminal 100 (POS terminal 300), but the embodiments are not limitative. For example, these files may be stored in an external device which the POS terminal 100 (POS terminal 300) can access.

Further, in the above embodiments, the service label feature file 217b and the grade label feature file 217c are stored in the product code reader 200 (product code reader 400), but the embodiments are not limitative. For example, these files may be stored in an external device which the product code reader 200 (product code reader 400) can access.

Further, the programs executed by the POS terminal 100 (POS terminal 300) and the product code reader 200 (product code reader 400) in the above embodiments may be recorded and provided in a computer readable recording medium such as a CD-ROM (Compact Disc Read Only Memory), a flexible disc (FD), a CD-R (Compact Disc Recordable), or a DVD (Digital Versatile Disc) as a file of a format which is capable of being installed or executed.

Further, the programs executed by the POS terminal 100 (POS terminal 300) and the product code reader 200 (product code reader 400) in the above embodiments may be stored in a computer connected with a network such as the Internet, and then may be downloaded and provided through the network. Further, the programs executed by the POS terminal 100 (POS terminal 300) and the product code reader 200 (product code reader 400) in the above embodiments may be provided or distributed through a network such as the Internet.

What is claimed is:

1. A product information processing apparatus comprising:
an image importing section which imports an image imaged by an imaging section;
a service label detecting section which detects a service label in which incentive content obtained from purchasing of the product is expressed in a visually unrecognizable form, from a product image imported by the image importing section; and
a notifying section which notifies the incentive content of the service label detected by the service label detecting section.

2. The apparatus according to claim 1, further comprising a discounting section which discounts a discount amount according to the service label detected by the service label detecting section from the price of the product,
wherein the notifying section notifies the discount amount.

3. The apparatus according to claim 2, further comprising an input receiving section which receives an input of grade information indicating the grade of a member who purchases the product,
wherein the discounting section discounts a discount amount according to a combination of the type of the service label detected by the service label detecting section and the grade information received by the input receiving section from the price of the product.

4. The apparatus according to claim 3,
wherein the input receiving section includes:
a card reading section which reads, from a membership card distributed to the member, member identification information retained in the membership card; and
a grade reading section which reads grade information corresponding to the member identification information read by the card reading section from a member management file in which the member identification information allocated to each member and the grade information of the member are matched with each other.

5. The apparatus according to claim 3,
wherein the input receiving section includes a grade label detecting section which detects a grade label in which the grade of the member who purchases the product is expressed in a visually unrecognizable form, from the product image imported by the image importing section.

6. The apparatus according to claim 2, further comprising a code reading section which detects a code symbol affixed to the product from the product image imported by the image importing section and reads a product code retained in the code symbol,
wherein the discounting section reads the price of the product corresponding to the product code read by the code reading section from a product management file in which the product code identifying each product and the price of the product are matched with each other and performs the discount from the read price.

7. The apparatus according to claim 1,
wherein the service label detecting section detects the service label from the image imported by the image importing section on the basis of a feature file which defines a feature of the service label for each type of service label.

8. The apparatus according to claim 1,
wherein the service label detecting section detects a predetermined graphic symbol affixed to the product as the service label.

9. The apparatus according to claim 1,
wherein the service label detecting section detects a predetermined logo type affixed to the product as the service label.

10. A product information processing method comprising:
importing an image imaged by an imaging section;
detecting a service label in which incentive content obtained from purchasing of the product is expressed in a visually unrecognizable form, from a product image imported in the image importing; and
notifying the incentive content of the service label detected in the service label detecting.
